(19) United States
(12) Patent Application Publication
(10) Pub. No.: US 2007/0060208 A1
(43) Pub. Date: Mar. 15, 2007

(54) System and method for alert by a calling user of a telecommunication terminal

(76) Inventors: Sophie Coste-Martinez, Lannion (FR); Yveline Chevalier, Paris (FR); Boris Pinatel, Paris (FR)

Correspondence Address: YOUNG & THOMPSON, 745 SOUTH 23RD STREET, 2ND FLOOR, ARLINGTON, VA, 22202, US

(21) Appl. No.: 11/514,936

(22) Filed: Sep. 5, 2006

(30) Foreign Application Priority Data
Sep. 6, 2005 (FR) 05 09098
Sep. 16, 2005 (FR) 05 09507

(51) Int. Cl. H04B 1/38

(52) U.S. Cl. 455/567

(57) ABSTRACT

A system for alert, in a telecommunications network, by a calling user a receiving user belonging to a community of users defined by an alert identifier, and the system including: a telecommunication terminal which belongs to the calling user and includes elements which can be activated by means of a predetermined button, for generation of a communication request including the alert identifier; an obtainability server which is connected to the telecommunication network in order to receive this communication request, and comprising: elements for receiving by the network the location coordinates of the terminals which are connected to the said network; and elements for selecting of a user belonging to the said community of users, such that the location of this user is the closest one to the terminal of the calling user; and elements for call redirecting in order to place the calling user in communication with the selected user.

The present invention relates to a system and a method for alert in a telecommunication network, by a calling user, to a receiving user belonging to a community of users, this community being identified by an alert identifier.

### BACKGROUND OF THE INVENTION

Telecommunication devices are known in which a calling user uses a specific device to initiate dialing of a telephone number corresponding to a particular contact person in order to alert the said contact person of an incident. These systems are operated by elderly or handicapped people who are staying at home, within a fixed telephony network, in order to alert the emergency services (ambulance, fire brigade, etc). The systems are in the form of an object with a single button carried by the people concerned, or in the form of a clearly distinguished button on a fixed or portable telephone keypad.

This type of system has the disadvantage that it cannot be used outside the home of the user, for example when travelling.

Another disadvantage is the limitation of the call to a single number, or to a few numbers for the most sophisticated devices. In the latter case, the numbers are dialed in succession until one of them answers. This dialing order is established during the initialisation of the device. If the first numbers called in the list are unavailable, valuable time is wasted by the system in trying to contact them.

The object of the invention is to propose an alert system and an associated method which do not have these disadvantages, and can therefore be used within any type of access network (fixed, mobile, Internet) to connect to the most appropriate contact person within a list of contact persons.

### SUMMARY OF THE INVENTION

The object of the invention is thus a system for alert, in a telecommunication network, by a calling user, to a receiving user belonging to a community of users, the said community being defined by an alert identifier, and the said system comprising:
a telecommunication terminal which belongs to the calling user, and comprises means for generation of a communication request comprising the said alert identifier;
an obtainability server which is connected to the telecommunication network in such a way that the communication requests comprising the alert identifier are directed to the said obtainability server, and the said obtainability server comprising:
   means for communication with the telecommunications network in order to receive the localization coordinates of the terminals which are connected to the said network; and
   means for selection of a user belonging to the said community of users, such that the localization of the user is the closest one to the terminal of the calling user; and
   means for call redirecting in order to place the calling user in communication with the selected user.

The alert system thus advantageously permits to select the receiving user who is geographically or temporally closest to the calling user, irrespective of the location of the said calling user. In particular, the calling user can thus advantageously use the alert system away from one's home, whilst travelling.

Other characteristics are:
the system additionally comprises a list server connected to the said obtainability server, the said list server comprising means for storing the list of users belonging to the community and availability data, and the means for selection of the obtainability server are adapted so that the said selection relates only to the users declared as being available at the moment of generation of the communication request;
the system also comprises a presence server which is connected to the said obtainability server, the said presence server permitting modification of the availability data by the users in the community of users;
at least one of the users is mobile;
the obtainability server also comprises means for sending an information message to all the users not selected in the community of users; and
the said generation means can be activated by means of a predetermined button of the said terminal.

Another object of the invention is a method for alert, in a telecommunications network, by a calling user to a receiving user belonging to a community of users, the said community being defined by an alert identifier, and the said method comprising the steps of:
a) receiving, at an obtainability server connected to the telecommunication network, a communication request comprising the said alert identifier, the said request being generated via a telecommunication terminal belonging to the calling user;
b) determining the localization coordinates of the communication terminal of the calling user;
c) selecting a user belonging to the said community of users, such that the location of this user is the closest one to the terminal of the calling user; and
d) redirecting of the communication request, in order to place the calling user in communication with the selected user.

Other characteristics of this method are that:
it comprises a prior step of storing the list of users belonging to the community and of availability data, and the selection relates only to users who are declared as being available at the moment of generation of the communication request;
the availability data can be modified by the users in the community of users;
after the step d) the method additionally comprises a step of transmitting a message destined for non-selected users in the community of users, the said message comprising at least the information related to the calling user, the selected user, and their respective locations; and
the request is generated upon activation of a predetermined button of the telecommunication terminal which belongs to the calling user.

Another object of the invention is a computer program comprising program code instructions for executing the steps of the method when the said program is executed on a computer.

Another object of the invention is an obtainability server, characterised in that it is connected to a telecommunication network, so as communication requests comprising an alert identifier which defines a community of users are directed to the said obtainability server, and in that it comprises:
means for communication with the telecommunications network in order to receive the localization coordinates of the terminals connected to the said network; and
means for selecting a user belonging to the said community of users, such that the location of this user is the closest one to a terminal of a calling user having generated a communication request comprising the said alert identifier; and
means for call redirecting in order to place the calling user into communication with the selected user.

Another object of the invention is a computer program product implemented by the obtainability server, comprising program code instructions for execution of the following steps:
receiving the localization coordinates of the terminals connected to the said network; and
selecting a user belonging to the said community of users, such that the location of this user is the closest one to a terminal of a calling user having generated a communication request comprising the said alert identifier; and
redirecting the call in order to place the calling user into communication with the selected user.

Thus, highly advantageously, the contact person who is called in priority is the one who is available, and for example who is geographically or temporally the closest to the calling user, which permits rapid intervention in case of emergencies.

In addition, since only the contact persons who are available are called, the system is more efficient, and no time is wasted.

Since the availability of the users of the community can be updated by the users themselves, the alert system gains in flexibility.

More over, the transmission of messages advantageously provides the members of the community with immediate information, which allows them to be informed and eventually to intervene specifically outside the selection rules and criteria, thus further increasing the flexibility.

### DESCRIPTION OF THE DRAWINGS

The invention will be better understood by reading the following description, provided purely by way of example and with reference to the attached drawings, in which:

FIG. 1 is a synoptic diagram of an embodiment of a system according to the invention;

FIG. 2 is a flowchart of an embodiment of the method according to the invention;

FIG. 3 is a synoptic diagram of a first variant of a system according to the invention;

FIG. 4 is a flowchart for a variant of the method corresponding to the system in FIG. 3;

FIG. 5 is a synoptic diagram of a second variant of a system according to the invention; and

FIG. 6 is a flowchart for a variant of the method corresponding to the system in FIG. 5.

### DESCRIPTION OF PREFERRED EMBODIMENTS

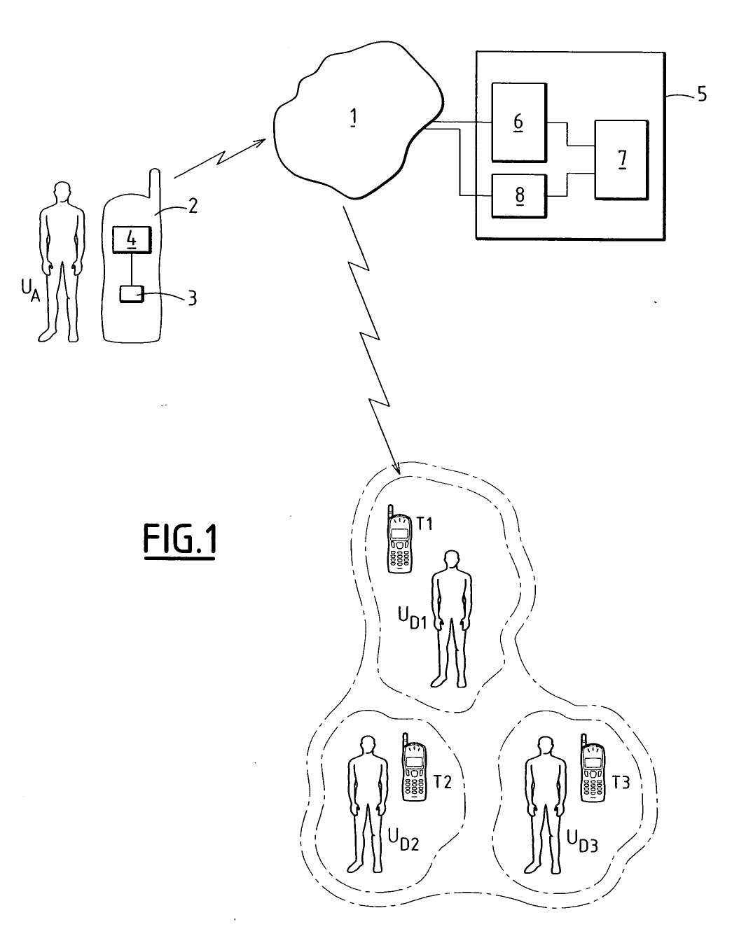

With reference to FIG. 1, a system for alert in a telecommunications network 1 comprises a telecommunication terminal 2 belonging to a user U_{A}.

By way of example, this user U_{A} is an elderly person having subscribed to a care service and using a mobile terminal 2.

This user U_{A} is mobile in the sense that he does not stay at home permanently.

The mobile terminal 2, which is permanently carried by the user U_{A}, comprises a button 3. Pressing of this button 3 by the user U_{A} activates means 4 for generating a communication request comprising an alert identifier. For example, pressing the button 3 triggers sending of a request with the alert identifier. This alert identifier has for example been stored in the mobile terminal 2 during an initialisation phase carried out when the user U_{A} subscribed to the care service.

The care service is provided by a community of users U_{D1}, U_{D2}, U_{D3}.

Each of these users U_{D1}, U_{D2}, U_{D3} has a mobile terminal T₁, T₂, T₃ which is connected to the telecommunications network 1.

The service alert identifier, which is one of the parameterisation elements of the service, is a distinct reserved identifier of the identities of all of the users.

This community of users U_{D1}, U_{D2}, U_{D3} contains for example all of the general practitioners/nurses in a town.

The system for alert comprises an obtainability server 5 which is connected to the telecommunication network 1. The access identifier of this obtainability server 5 corresponds to the alert identifier parameterised in the mobile terminal 2, such that the telecommunications network 1 directs the communication request from the mobile terminal 2 to the obtainability server 5.

The obtainability server 5 comprises means 6 for communication with the network 1, such that the obtainability server receives the localization coordinates of a terminal that is connected to this network 1.

It is well known to a person skilled in the art that the present fixed and mobile communication networks comprise localization servers which can determine the localization coordinates of any terminal connected to these networks. Thus, for mobile terminals, depending on the precision required, this localization can be limited to determining the geographical area corresponding to the coverage of the base station connected to the mobile terminal, or it can use triangulation methods by using the signals transmitted from the mobile telephone to its attached base station and the adjacent base stations. For fixed networks, the localization information is in general provided by translating the line identifier.

The means 6 sends location requests to the localization server of the network 1, the said request comprising the access number of the terminal to be localized, and in return receives a response comprising the location of this terminal, provided that the said terminal is connected to the network 1. The location information of the caller can also be transmitted automatically by the localization server of the network 1 in the initial request that is sent to the obtainability server 5, and is therefore received by the means 6.

The obtainability server 5 comprises means 7 for selecting a user U_{D1} belonging to the community of users U_{D1}, U_{D2}, U_{D3}.

The criterion for selection of the user U_{D1} is one's proximity to the calling user U_{A}. Proximity means either the geographic proximity, i.e. the shortest distance between the calling user U_{A}and the user to be selected, or the temporal proximity, corresponding to the time necessary for the user to be selected to come to contact the calling user U_{A}.

The obtainability server 5 also comprises call redirecting means 8 which are connected to the selection means 7, in order to place the calling user U_{A} in communication with the receiving user U_{D1} selected, the communication preferably being of the multimedia type.

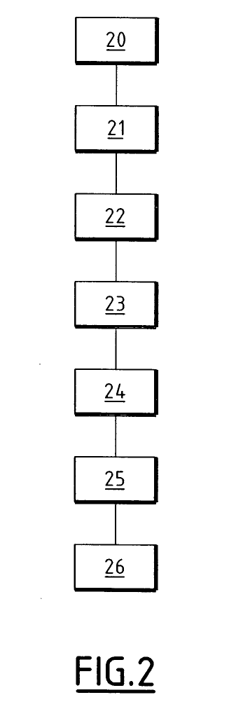

The operation of this alert system will now be explained with reference to FIG. 2.

The calling user U_{A} presses at 20 the call button 3, which activates the means 4 for generating a communication request.

The said means transmit at 21 a communication request comprising at least the alert identifier and the identifier of the caller U_{A}.

This request is sent at 22 by the telecommunication network 1 to the obtainability server 5.

On receipt of this request, the obtainability server 5 determines at 23 the localization coordinates of the calling user U_{A}, or, more specifically, his mobile terminal 2. This determination of the location is carried out by the localization server of the telecommunication network 1 and is transmitted to the communication means 6.

The obtainability server 5 selects at 24 the user U_{D1}, U_{D2}, U_{D3} out of the community of users who is closest to the calling user U_{A}. For example, for a search for geographical proximity, the obtainability server 5 interrogates the network 1 using its communication means 6 to determine all of the localization coordinates of the users U_{D1}, U_{D2}, U_{D3}, then it calculates the distance in a straight line between the calling user U_{A} and each of the users U_{D1}, U_{D2}, U_{D3} in order to select the one who is the shortest distance away. It will be appreciated that other route calculation methods which are well-known to persons skilled in the art can be used, such as search methods used in route itineraries. If the proximity sought is temporal, i.e. if the search concerns the user U_{D1}, U_{D2}, U_{D3} who can reach the calling user U_{A} the most quickly, the methods for itinerary search and of travel time calculation are used. These methods can be used with real time traffic data, thus making it possible to adjust the travel time to the actual traffic conditions. By way of illustration, U.S. Pat. No. 6,539,302 belonging to Bender et al describes a calculation method of this type.

Having determined the closest user U_{D1}, U_{D2}, U_{D3}, the server redirects at 25 the communication request to the telephone T1 of this user. For this purpose it uses the conventional mechanism of call redirecting, for example.

Then the telecommunication network 1 establishes at 26 the communication between the calling user U_{A} and the user U_{D1}. Preferably, this communication is of the multimedia type, for example in the form of visual telephony.

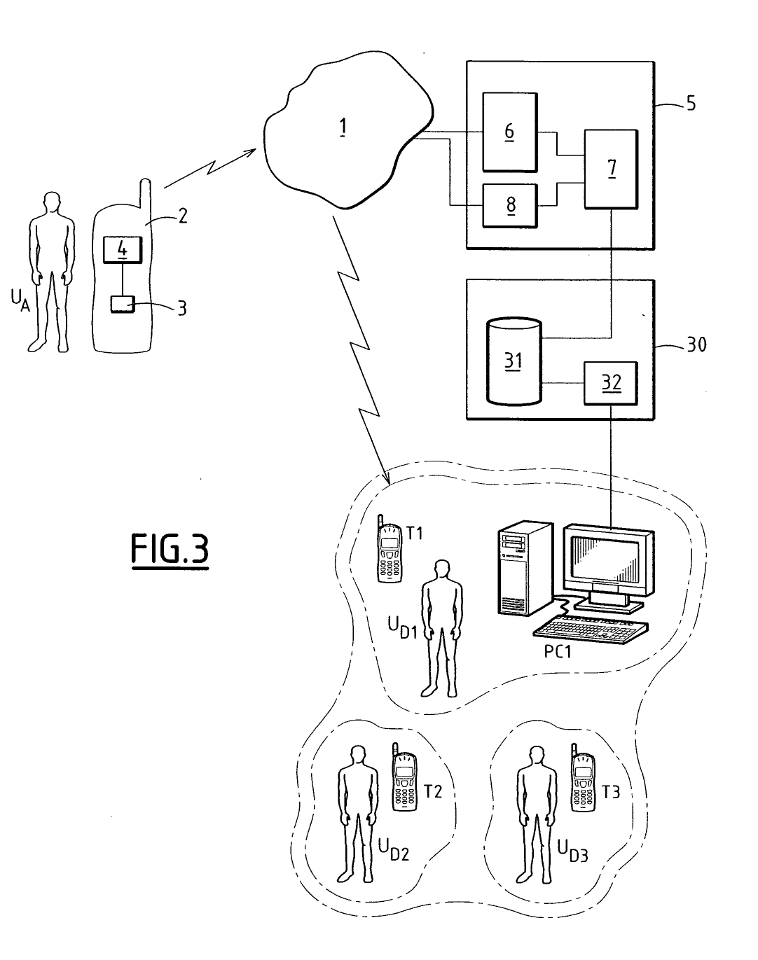

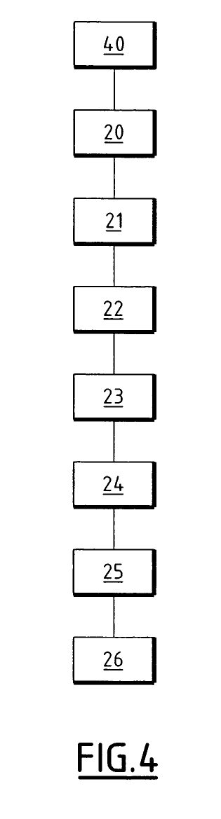

A variant embodiment is shown in FIGS. 3 and 4, in which identical or similar elements have the same reference numerals.

The alert system additionally comprises a lists server 30 which is connected to the obtainability server 5. This list server 30 comprises means 31 for storing of the list of users U_{D1}, U_{D2}, U_{D3} in the community of users. For each user, the storage means 31 stores the availability of each user.

In this context, the availability can correspond to the hourly or daily periods during which the user is available to respond to a call sent by the alert system. Thus, in the example previously cited, in which the community of users corresponds to all of the general practitioners/nurses in a town, the availability thereof corresponds to the periods when they are on duty or restrained.

The selection means 7 are then adapted to select the user U_{D1} who is available, and is closest to the calling user U_{A} when the latter calls.

In a preferred embodiment, the list server 30 interfaces with a presence server 32 which permits modification of the availability data by the users U_{D1}, U_{D2}, U_{D3} in the community of users.

By way of illustration, the personal computer PC₁ of the user U_{D1} is connected to the presence server 32, so that this user can update his availability. The users U_{D2} and U_{D3} use their terminals T2 and T3 to carry out this updating.

Since the users U_{D1}, U_{D2}, U_{D3} have stored their availability in the presence server 32 at 40, the selection at 24 involves only the users U_{D1}, U_{D2}, U_{D3} who have declared that they are available at the moment of the call.

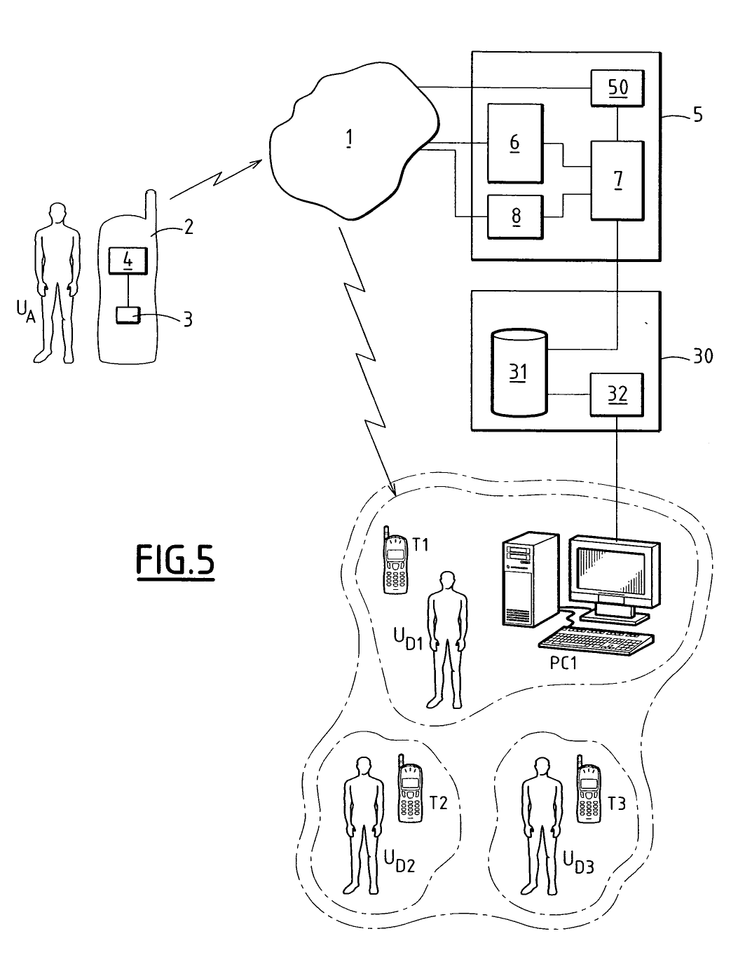

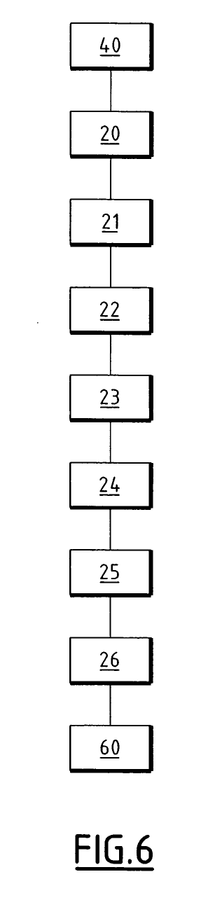

A second variant is illustrated in FIGS. 5 and 6, in which the elements which are identical or similar have the same references as hereabove.

The obtainability server 5 comprises means 50 for sending messages, which are connected to the selection means 7 as well as to the telecommunication network 1.

At 60, after placing a communication between the calling user and the user U_{D1}, the obtainability server sends a message, for example an SMS, to the other members of the community U_{D2}, U_{D3} to notify them of this placing of communication. The message contains at least information related to the two users placed into communication, for example their respective identifiers and location.

It should be noted that this second variant is independent from the first variant, and can be implemented without implementation of the first variant.

According to a preferred embodiment, the telecommunications network comprises an IMS CORE network. This network is defined by the standard 3GPP TS 23.228 “IP multimedia subsystem (IMS): stage 2”. This network centralises and standardises the relations with and between the different services offered, and interfaces with all types of access network (fixed, mobile, Internet). Thus, within the context of the alert system, all the requests and responses previously described as part of the telecommunication network are controlled by this IMS CORE network. The services are provided by applications servers like the presence server and the obtainability server. In the IMS CORE network, the service alert identifier advantageously forms part of the “Public Service Identities”.

It will be appreciated that the alert process is executed by the obtainability server, which is a computer device, under the control of software instructions by a computer programme. Accordingly, the invention also relates to a computer program comprising software instructions to enable the obtainability server to execute the method previously described.

1. A system for alert, in a telecommunications network, by a calling user to a receiving user belonging to a community of users, the said community being defined by an alert identifier, and the said system comprising:
a telecommunication terminal which belongs to the caller user and comprises means for generation of a communication request comprising the said alert identifier;
an obtainability server connected to the telecommunication network so that the communication requests comprising the alert identifier are directed to the said obtainability server, and the said obtainability server comprising
means for communication with the telecommunications network in order to receive the localization coordinates of the terminals connected to the said network; and
means for selecting a user belonging to the said community of users, such that the localization of this user is the closest to one to the terminal of the calling user; and
means for call redirecting in order to place the calling user into communication with the selected user.

2. An alert system according to claim 1, wherein the system additionally comprises
a list server connected to the said obtainability server, the said list server comprising means for storing the list of users belonging to the community and availability data, and wherein the means for selecting the obtainability server are adapted so that the said selection relates only to the users declared available at the moment of generation of the communication request.

3. An alert system according to claim 2, wherein the system further comprises a presence server which is connected to the said list server, the said presence server permitting modification of the availability data by the users in the community of users.

4. An alert system according to claim 1, wherein at least one of the users is mobile.

5. An alert system according to claim 1, wherein the obtainability server further comprises means for sending an information message to all the users not selected in the community of users.

6. An alert system according to claim 1, wherein the said generation means can be activated by means of a predetermined button of the said terminal.

7. A method for alert, in a telecommunications network, by a calling user to a receiving user belonging to a community of users, the said community being defined by an alert identifier, and the said method comprising the steps of:
a) receiving at an obtainability server connected to the telecommunication network, a communication request comprising the said alert identifier, the said request being generated via a telecommunication terminal which belongs to the calling user;
b) determining the localization coordinates of the communication terminal of the calling user;
c) selecting a user belonging to the said community of users, such that the location of this user is the closest one to the terminal of the calling user; and
d) redirecting the communication request, in order to place the calling user in communication with the selected user.

8. A method for alert according to claim 7, wherein the method comprises a prior step of storing the list of users belonging to the community and of availability data, and the selection relates to only users who are declared available at the moment of generation of the communication request.

9. A method for alert according to claim 8, wherein the availability data can be modified by the users in the community of users.

10. A method for alert according to claim 7, wherein after the step d) the method additionally comprises a step of transmitting a message destined for non-selected users in the community of users, the said message comprising at least the information related to the calling user, the selected user, and their respective locations.

11. A method for alert according to claim 7, wherein the request is generated upon activation of a predetermined button of the telecommunication terminal which belongs to the calling user.

12. A computer program product comprising program code instructions for executing the steps of the method according to claim 7 when the said programme is executed on a computer.

13. An obtainability server, wherein the obtainability server is connected to a telecommunication network, so as communication requests comprising an alert identifier which defines a community of users are directed to the said obtainability server, and wherein the server comprises:
means for communication with the telecommunication network in order to receive the localization coordinates of the terminals which are connected to the said network; and
means for selecting a user belonging to the said community of users, such that the location of this user is the closest to one to a terminal of a calling user having generated a communication request comprising the said alert identifier; and
means for call redirecting in order to place the calling user into communication with the selected user.

14. A computer program product implemented in an obtainability server according to claim 13, comprising program code instructions for execution of the following steps:
receiving the localization coordinates of the terminals connected to the said network; and
selecting of a user belonging to the said community of users, such that the location of this user is the closest one to a terminal of a calling user having generated a communication request comprising the said alert identifier; and
redirecting the call in order to place the calling user into communication with the selected user.
